(19) United States
(12) Patent Application Publication
(10) Pub. No.: US 2025/0013893 A1
(43) Pub. Date: Jan. 9, 2025

(54) DYNAMIC GENERATIVE-AI ENHANCED LEADERSHIP COACHING PLATFORM

(71) Applicants: Jonathan Raymond, Encinitas, CA (US); Matt Parson, Toronto (CA)

(72) Inventors: Jonathan Raymond, Encinitas, CA (US); Matt Parson, Toronto (CA)

(21) Appl. No.: 18/765,250

(22) Filed: Jul. 6, 2024

Related U.S. Application Data
(60) Provisional application No. 63/525,354, filed on Jul. 6, 2023.

(51) Int. Cl. G06N 5/043; G06F 16/9032; G06F 21/40; G06F 40/186; G06F 40/35; G06F 40/40; G06Q 50/20

(52) U.S. Cl. CPC G06N 5/043; G06F 16/90332; G06F 21/40; G06F 40/186; G06F 40/35; G06F 40/40; G06Q 50/2057

(57) ABSTRACT

A dynamic generative-AI enhanced leadership coaching platform includes an agent, an authentication module, an event processor, a user interface module, a router, a generative AI module having a prompt compiler module, a post-conversation analysis module, a prompt template library, an API interface module, a memory management module having a vector-search module, a vectorized database module configured to store vectorized data records and be accessible to the memory management module, a vectorization module configured to vectorize data, a knowledge base database module configured to catalogue vectorized data, and a user profile stored in the user database including a dynamic data point, a personalized conversation starter, and a user permission set.

### CROSS REFERENCE TO RELATED APPLICATION

This application claims the benefit of U.S. Provisional Application Ser. No. 63/525,354, filed Jul. 6, 2023, the entirety of which is incorporated by reference herein.

### BACKGROUND OF THE INVENTION

### Technical Field

Aspects of some embodiments of the present disclosure relate to the field generative artificial intelligence (“AI”) enhanced leadership coaching and executive development software platforms. More specifically, aspects of some embodiments of the present invention may be directed to a generative AI enhanced leadership coaching platform architecture, and memory management implementation within that platform, that may facilitate new possibilities for providing individualized and dynamic leadership coaching across an organization without risking the introduction of bias between employees and coaches.

### Problems that are to be Solved by the Invention

As mentioned previously, aspects of some embodiments of the present disclosure may be directed to providing individualized and dynamic leadership coaching for employees and executives across an organization. One of the biggest challenges in providing leadership coaching and/or executive development instruction within an organization is to provide individualized coaching without introducing bias to the instructors that may have to see other employees that are involved in potentially sensitive matters. For example, an intraoffice dispute between two team members may require a leadership coach to speak with both members of the team, or other members that are not directly involved in the dispute, and the information received from one team member may improperly color the coaching provided to the next team member. Aspects of some embodiments of the present disclosure may also be directed to a generative AI enhanced leadership coaching platform that may allow for multiple employees, executives, or team members to receive individualized and dynamic leadership coaching, in parallel (i.e., at overlapping times), across remote locations without having to worry about biasing the instructors or having sensitive information shared by instructors to other coaching recipients.

### Means for Solving the Problem

Aspects of some embodiments of the present disclosure are directed to generative AI enhanced leadership coaching platforms that may mitigate the aforementioned difficulties by providing individualized dynamic coaching to employees, executives, and team members while allowing for increased privacy, efficiency, and auditability. The implementation of user profiles having user-level permissions and organization-level permissions may, in some embodiments, allow for one or more users to be provided with coaching that is customized not only to the individual's current and past interactions with the system, but that is also responsive to the individual's role within the organization. This may, in some embodiments, allow for entire teams of individuals having similar roles to receive the same core instruction from the platform while also providing them individualized coaching. Moreover, the knowledge base materials used within the retrieval-augmented generation (RAG) processes of the platform may also be structured according to these permissions allowing each individual to get access only to those coaching materials that match his or her permission level. This may, in some such embodiments, allow for increased privacy for individuals receiving coaching, as their interactions with the system may be maintained securely stored and be accessible only to those users with the appropriate permissions. In some embodiments, these features may be implemented in concert with a memory management infrastructure that may include the use of vectorized databases and searches alongside non-vectorized databases to improve response times while maintaining accurate data for future recall by the platform. Combining these features may, in some embodiments, allow the platform of the present disclosure to provide individualized dynamic coaching to individuals across different role and remote locations in parallel for an entire organization.

### Effect of the Invention

As mentioned previously, some embodiments of the present disclosure may allow for an organization to use the platform of the present disclosure to provide individualized and dynamic leadership coaching and/or executive training to multiple employees and/or executive across different roles and locations. The coaching sessions may be coordinated, monitored, and audited to gain new insights into both the individuals being trained as well as the reception different employees/executives have to different training materials. Organization specific training materials may, in some embodiments, be incorporated into the knowledge base of the system to allow for coaching that is customized to the policies of the organization. Employees and executives receiving leadership coaching and/or receiving coaching on sensitive subjects may, in some embodiments, be able to interact more candidly with the platform knowing that their interactions with the platform may be securely stored and their interactions will not be spread by the platform to other users. Individual, role, team, department, and organization based audits may be provided by the platform to allow new insights and feedback to be gained from the leadership coaching of the system that was not otherwise possible to provide while also maintaining a meaningful level of privacy for the individuals receiving coaching. All of these features may, in some embodiments, be available to an organization at all times of day, across multiple locations, providing a level of flexibility and availability for leadership coaching that was never before possible.

### SUMMARY OF THE INVENTION

One or more embodiments of the present disclosure may be directed to a dynamic generative-ai enhanced leadership coaching platform.

A dynamic generative-AI enhanced leadership coaching platform includes an agent having a semantic analysis module and a chat vectorization module, an authentication module configured to authenticate one or more users in response to receiving one or more user authentication credentials, an event processor configured to schedule tasks performed by the agent, a user interface module configured to send and receive messages from one or more authenticated users during a chat session, a router having a search comparator module, a generative AI module having a prompt compiler module, a post-conversation analysis module configured to send prompt-based instructions to the generative AI module to generate an analysis and summary of a chat transcript of messages from the one or more authenticated users during the chat session and to receive the analysis and summary from the generative AI module, a prompt template library configured to be accessible to the prompt compiler of the generative AI module, an API interface module configured to communicate with one or more generative AI models using the API interface available for each generative AI model, respectively, a memory management module having a vector-search module, a vectorized database module configured to store vectorized data records and be accessible to the memory management module, a vectorization module configured to vectorize data, a knowledge base database module configured to catalogue vectorized data, a client resource database accessible to the knowledge base database module and configured to store client resource materials, a leadership coaching database accessible to the knowledge base database module and configured to house leadership coaching materials, a chat history database configured to store the chat transcript, a user database configured to store a user profile, and a user profile stored in the user database.

The dynamic generative-AI enhanced leadership coaching platform may have the messages from the one or more authenticated users during the chat session include audio recordings.

The dynamic generative-AI enhanced leadership coaching platform may have the search comparator module of the router be configured to select one or more vectorized data records returned by the vector-search module in response to an evaluation of the cosine similarity of the one or more vectorized data records against a threshold value.

The dynamic generative-AI enhanced leadership coaching platform may have the one or more generative AI models include an internal generative AI model.

The dynamic generative-AI enhanced leadership coaching platform may have the one or more generative AI models include an external generative AI model. The dynamic generative-AI enhanced leadership coaching platform may have the user profile include a dynamic data point, a personalized conversation starter, and a user permission set, wherein the user permission set includes a user-level permission and an organization-level permission.

The dynamic generative-AI enhanced leadership coaching platform may have the one or more authenticated users each be assigned an access level to one or more vectorized data records according to the user-level permission of each of the one or more authenticated user's user profile, respectively.

The dynamic generative-AI enhanced leadership coaching platform may have the one or more authenticated users each be assigned an access level to one or more vectorized data records according to the organization-level permission of each of the one or more authenticated user's user profile, respectively.

The dynamic generative-AI enhanced leadership coaching platform may have the dynamic data point include one or more components of the analysis and summary of the chat transcript according to the instructions of the post-conversation analysis module.

The dynamic generative-AI enhanced leadership coaching platform may have the post-conversation analysis module be configured to instruct the generative AI module to generate the summary and analysis of the chat transcript in response to a chat session termination event.

A method for providing a dynamic generative-AI enhanced leadership coaching platform includes opening, by an agent, a chat session, receiving, by the agent, a message from a user sent from a user interface module, recording, by the agent, the message from the user in a chat transcript, creating, by a semantic analysis module of the agent, a semantic analysis of the message from the user, vectorizing, by a chat vectorization module of the agent, the semantic analysis of the message from the user, sending, by the agent, a vectorized data chunk retrieval request to a memory management module based upon the vectorization of the semantic analysis of the message from the user, retrieving, from a vectorized database by the memory management module, one or more vectorized data chunks, returning, by the memory management module, the one or more vectorized data chunks to a router, determining, by a search comparator module of the router, a similarity score for each of the returned one or more vectorized data chunks based upon the vectorization of the message from the user, selecting, by the router, a similar subset of the one or more returned vectorized data chunks that have an evaluated similarity score exceeding a threshold value, sending, by the agent, a user profile request to a user database, retrieving, by the user database, a user profile associated with the user including a dynamic data point and a personalized conversation starter, returning, by the user database, the user profile associated with the user to the agent, selecting, by a generative AI module, a prompt template from a prompt template library, receiving, by a prompt compiler of the generative AI module, the similar subset of the vectorized data chunks from the agent, compiling, by the prompt compiler, a dynamic prompt by appending the message from the user, the chat transcript, the similar subset of the vectorized data chunks, and the user profile to the prompt template, sending, by the generative AI module, the dynamic prompt to a generative-AI model, receiving, by the generative AI module, a generated response including a responsive message for the user from the generative-AI model, and sending, by the agent, the responsive message for the user to the user.

The method for providing a dynamic generative-AI enhanced leadership coaching platform may include receiving, by the agent, a chat termination event, sending, by the agent in response to the chat termination event, a user profile update request to the generative AI module including instructions to generate an update to the user profile associated with the user, an updated dynamic data point, and an updated conversation starter based upon the chat transcript of the chat session, returning, by the generative AI module to the agent, the update to the user profile associated with the user, the updated dynamic data point, and the updated conversation starter, sending, by the agent, the update to the user profile, the updated dynamic data point, and the updated conversation starter to the user database, incorporating, by the user database, the update to the user profile, the updated dynamic data point, and the updated conversation starter into the user profile associated with the user.

The method for providing a dynamic generative-AI enhanced leadership coaching platform may have the vectorized data chunks include a data file and a vector embedding.

The method for providing a dynamic generative-AI enhanced leadership coaching platform may have the similarity score be determined by performing a cosine similarity evaluation between the vector embeddings of the vectorized data chunks and the vectorization of the semantic analysis of the message from the user.

The method for providing a dynamic generative-AI enhanced leadership coaching platform may have the generative AI model include a large language model.

The method for providing a dynamic generative-AI enhanced leadership coaching platform may include requesting, by the agent, a permission set associated with the user profile of the authenticated user, and sending, by the agent, the permission set associated with the user profile to the memory management module to define a portion of the vectorized database that may be searched.

An organization-wide dynamic generative-AI enhanced leadership coaching platform includes an authentication module configured to authenticate a plurality of users, a user interface module configured to send and receive messages, an agent configured to instantiate a plurality of independent chat sessions associated with one or more of the plurality of users, respectively, a user database including a plurality of user profiles for each respective user of the plurality of user a memory management module, and a generative AI module, wherein the agent is configured to run two or more of the plurality of independent chat sessions at the same time, wherein the agent sends search requests based on vectorized semantic analyses of chat transcripts of the two or more independent chat sessions to the memory management module, and wherein the memory management module returns to the agent one or more vectorized data chunks for each search request that are selected based on similarity and then compiled into one or more dynamic prompts sent by the agent to the generative AI module.

The organization-wide dynamic generative-AI enhanced leadership coaching platform may have the agent be further configured to, in response to a chat session termination event for one of the plurality of independent chat sessions, send a chat transcript from the terminated chat session alongside an instructive prompt to the generative AI module to request an update to the user profile of the user associated with the terminated chat session and an updated dynamic data point associated with the user profile of the user associated with the terminated chat session.

The organization-wide dynamic generative-AI enhanced leadership coaching platform may have the user profile for each respective user of the plurality of users includes one or more permission levels defining a portion of a knowledge base database that may be accessed by the user.

The organization-wide dynamic generative-AI enhanced leadership coaching platform may have the agent be configured to produce an audit report describing trends in the chat sessions for one or more of the plurality of users.

### BRIEF DESCRIPTION

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a simplified depiction of the relationship of the modules of a dynamic generative-AI enhanced leadership coaching platform, according to aspects of some embodiments of the present disclosure.

FIG. 2. Is a simplified depiction of a generative AI module, according to aspects of embodiments of the present disclosure.

FIG. 3 is a simplified depiction of an agent in communication with a generative AI module, a router, and a memory management module, according to some aspects of embodiments of the present disclosure.

FIG. 4 is a simplified diagram depicting a user terminal in communication over a network with an agent hosted on a server network, according to some aspect of embodiments of the present disclosure.

FIG. 5 is a flowchart describing the process of a chat session being opened and a message from a user being vectorized, according to some aspects of embodiments of the present disclosure.

FIG. 6 is a flowchart describing the process of a dynamic search for one or more vectorized data chunks, according to some aspects of embodiments of the present disclosure.

FIG. 7 is a flowchart describing the process of requesting user profile data and combining it with one or more vectorized data chinks to compile a dynamic prompt, according to some aspects of embodiments of the present disclosure.

FIG. 8 is a flowchart describing the process of receiving generated content from a generative AI model and sending a responsive message to a user, according to some aspects of embodiments of the present disclosure.

FIG. 9 is a flowchart describing the process of updating a user profile in response to a chat termination event, according to some aspects of embodiments of the present disclosure.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer, or section. Thus, a first element, component, region, layer, or section described below could be termed a second element, component, region, layer, or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more embodiments according to the present disclosure will now be described.

### Dynamic Generative-AI Enhanced Leadership Coaching Platform

Aspects embodiments of the present disclosure are directed to a retrieval-augmented generation enhanced leadership coaching platform configured to integrate with a one or more generative AI models to provide dynamic and personalized leadership coaching that can be provided in parallel to users across an organization and corresponding methods for creation/operation thereof.

As will be understood by one skilled in the art, the structure of the platform described herein may be varied to allow the platform to be organized according to different architectures. These may include microservice architectures, fully serverless architectures, decentralized or distributed data management architectures, and/or hybrid cloud architectures. The detailed description of the platform provided herein is intended to be applicable to all of these architectures, though for convenience most of the following disclosures will describe the platform using a module/microservice architecture. All of these various different architectures, and any others as would be known to one skilled in the art to be suitable for this purpose, as within the scope of the present disclosure.

### I. Agent

In some embodiments, the communication system of the present disclosure may include an agent, host, shell, or operating environment configured to run, operate, instantiate, or otherwise execute one or more modules of the present disclosure. The agent may, in some embodiments, be configured to coordinate or otherwise monitor communications exchanged between the various modules and databases of the present disclosure described herein.

i. Semantic Analysis Module

In some embodiments of the present disclosure, the agent may include a semantic analysis module. The semantic analysis module may, in some embodiments, be configured to implement natural language processing (NLP) or other processes to break down textual content provided in a message from a user. As a non-limiting example, these processes, or sub-processes, may include part-of-speech tagging, named identity recognition, syntactic tagging/analysis, and semantic role labeling.

In some embodiments, the semantic analysis module may include a message received from a user in one or more prompts that may be sent to a large language model (LLM) with instructions to interpret and generate a single-statement response that captures or otherwise conveys the meaning of the message from the user. The single statement response may, in some embodiments, be returned to the semantic analysis module and then embedded as a multi-dimensional vector using one or more machine learning embedding models as would be known to one skilled in the art. In some other embodiments, the single statement response may be returned by the LLM with the vector embedding included.

ii. Chat Vectorization Module

As described above, in some embodiments, the agent may be configured to produce a multi-dimensional vector representation of one or more message received form a user, i.e., vectorize the messages. The vectorization may be performed using one or more vector embedding models as would be known to be suitable for this purpose by one skilled in the art.

### II. Authentication Module

In some embodiments, the dynamic generative AI enhanced leadership coaching platform of the present disclosure may include an authentication module. The authentication module may, in some embodiments, use one or more user credentials (i.e., authentication factors) to authenticate one or more users and grant them access to the platform. As will be appreciated by one skilled in the art, any authentication procedure or process as would be known to one skilled in the art may be used within the scope of the present disclosure. This may include the use of usernames and passwords, multi-factor authentication (MFA) methods, biometrics, single-sign on (SSO) authentication, token-based authentication, credential-based authentication, and or the use of platform authenticators such as FIDO2/WebAuthn.

### III. Event Processor

Aspects of embodiments of the present disclosure may be directed to an event handler, or event handler module, that may be configured to schedule and monitor tasks carried out by the agent and other modules of the platform. In some embodiments, multiple users may be communicating with the platform at the same time and/or being provided with individualized versions of the same core leadership coaching materials, i.e., be coached in “parallel.” In some such embodiments, the event handler may be configured to schedule the tasks of the platform in receiving messages and generating responses for multiple users. This may, in some embodiments, be performed by the event handle placing scheduled tasks into one or queues. In some other embodiments, the event handler may be configured to parallelize the scheduled tasks of the platform to be carried out on hardware that is configured for large, parallelized workloads, such as GPUs and multi-threaded CPUs.

In some embodiments, the event processor may organize and schedule tasks within the system pertaining to a user based on a leadership coaching schedule or program. In some other embodiments, the event processor may schedule tasks associated with a user based on one or more triggering events, progress objectives, or behavioral analyses of a user based on his or her interactions with the platform. As a non-limiting example, in some embodiments the receptiveness of a user to one or more leadership coaching materials may be analyzed and the event processor may schedule additional coaching for the user using alternative leadership coaching materials and/or methodologies based on the user's receptiveness.

### IV. User Interface Module

Communication with one or more users is, in some embodiments, carried out by a user interface module. The user interface module may, in some embodiments, include a chat or text-to-text communication interface configured to receive messages from and send messages to one or more users. In some other embodiments, the user interface module may be configured to communicate with one or more users using audio messages, video messages, or images. In such embodiments, the user interface module may be configured to include or interface with one or more additional modules to handle operations such as audio-to-text transcription, natural language processing, digital speech synthesis, computer vision and object recognition, and or language translation.

As a non-limiting example, in embodiments where one or more users may communicate with the platform using audio recordings, the user interface module may be configured to carry out audio-to-text transcription of the audio recordings before the transcribed recordings are semantically analyzed. Additionally, in some embodiments, the user interface module may be configured to allow the platform to respond back to a message received from a user with a digitally synthesized voice. This may, in some such embodiments, allow for the platform to interact with one or more users in a somewhat conversational manner. Such embodiments may also be beneficial for users with physical or visual impairments that may text-to-text communication with the platform difficult or burdensome.

As will be appreciated by one skilled in the art, there are various models and or external services accessible via APIs that may be used for these purposes, and all of those that would be known by one skilled in the art to be suitable for these purposes are within the scope of the present disclosure.

In some embodiments, the user interface module may be configured to communicate with one or more users via a command line type interface. In some other embodiments, a graphical user interface (GUI) may be rendered to provide users with alternative ways to input commands to the platform. In some such embodiments, the GUI may be configured to allow a user to select the mode of communication and to provide the appropriate interface. As a non-limiting example, a user may select to send an audio message to the platform, and the user interface module may be configured to provide a visual indicator to the use via the GUI that recording is taking place and/or display the recorded sound levels so that the user can adjust the recording volume and/or microphone placement to get sufficiently loud recordings. As another non-limiting example, in an embodiment where video messages may be sent by the user to the platform, the user interface module may be configured to provide a video playback window to allow a user to view the video recording he or she is capturing and sending to the platform.

The user interface module may also be configured to communicate with one or more users by providing an input or communication interface that may be displayed on a mobile device such as a tablet or a smart phone. In some such embodiments, the user interface module may be configured to communicate with one or more users through a mobile application.

In still other embodiments, the user interface module may be configured to receive messages, voice, text or otherwise, from one or more users that have been collected/recorded using a third-party application or interface. In such embodiments, the user interface module may be configured to include one or more APIs to allow the third-party interface to communicate with the platform of the present disclosure. As will be appreciated by one skilled in the art, there are various types of APIs that may be suitable for this purpose including, but not limited to, REST and SOAP APIs. All such APIs as would be known to one skilled in the art to be suitable for this purpose are within the scope of the present disclosure.

### V. Router

One of the significant technical challenges to providing leadership coaching using a generative AI model or models is that generative AIs typically are trained on very generalized data. Most models are intended to create quality answers to a wide variety of subjects for a large number of users. These types of generative AI models, such as LLMs, can be utilized in a process called retrieval-augment generation (RAG) where specific contextualizing data is sent to the generative AI alongside an instructive prompt to limit and guide the generative AI in generating a more customized response. However, even RAG has its limitations. For example, a generative AI model may be used for legal research and provided with a database of case law to draw inferences from and an instructive prompt that guides it in how to evaluate the content of legal precedents and return legal research as an RAG response. However, these types of responses are not really dynamic nor individualized for the user. The RAG process is simply always feeding the generative AI model the same contextualizing information.

Aspects of embodiments of the present disclosure may improve upon this technology by providing a router, or “router module,” configured to utilize user profile data, chat histories, and pertinent vectorized data chunks/files located through similarity searches on indexed vector databases to create individualized contextualizing data payloads for user communications that are being processed by the platform. In some embodiments, the router may be configured to provide focused contextualizing data for the RAG process that is responsive to the trends in the one or more users' conversations with the platform, i.e., the router may enable a “dynamic” structure for the RAG process. In some such embodiments, the router may be configured to work in connection with a memory management module to interpret communications received from one or more users and then select contextualizing data, in the form of vectorized data chunks, from an indexed vector database to provide responsive contextualizing information to a generative Ai model to perform dynamic RAG processes. Such embodiments are discussed in more detail below in the memory management module section.

i. Search Comparator

As discussed above, when a message/communication is received from a user, the platform of the present disclosure may, in some embodiments, process that message to convert it into a single-statement response and processed according to a vector embedding model to produce a multi-dimensional vector representation of the primary content of the message. In some such embodiments, this processing is performed by a chat vectorization module of the user interface module. In some other embodiments, this processing may be carried out by the agent or another module of the present disclosure. The vector embedding of the message received from the one or more users may, in some embodiments, be used to structure a search query within an indexed vector database by the memory management module or one of its component sub-modules. Results returned from such a search may then be narrowed down by a search comparator module of the router to evaluate the similarity of the vector embeddings of the search results relative to the vectorization of the message received from the user using a defined threshold similarity value.

There are many different ways that this type of similarity may be measured. As a non-limiting example, cosine similarity may be used to evaluate the similarity or “closeness” of the returned search results. Cosine similarity, i.e., the dot product of two vector embeddings divided by the product of the magnitude of the vector embeddings, is a computationally efficient and reliable way to measure the similarity of the returned search results. However, as will be appreciated by one skilled in the art, the present disclosure is not limited only to the use of cosine similarity to measure the similarity between two vector embeddings, and any suitable measurement method as would be known to one skilled in the art may be used within the scope of the present disclosure.

Once a measurement of the similarity for the search results has been determined, the search comparator module may evaluate the similarity measurements against a threshold value. The threshold value may, in some embodiments, thus determine how similar results must be in order for them to be included in the dynamic RAG process. In some embodiments, the threshold value may be adjusted in response to feedback received from one or more users if the RAG process is returning responses that appear to be too narrow or too broadly contextualized.

In some embodiments, the router may be configured to provide the selected, pertinent vectorized data chunks returned as search results by the memory management module, to a generative AI module to facilitate the dynamic RAG process.

### VI. Generative AI Module

In some embodiments, the platform may include a generative AI module to compile one or more prompts and to interface with one or more generative AI models to produce dynamic leadership coaching responses for one or more users. In some embodiments, these operations may be carried out by sub-modules of the generative AI module. Such sub-modules are discussed in detail below.

i. Prompt Compiler Module

Generative AI models return generated content, text, audio, images, etc., in response to a prompt from a user. In some application, a prompt may be combined with instructions to specify the nature of the returned response from the generative AI model or to limit the sources from which the generative AI model will draw inferences from. A more specific application of this, wherein the instructions are also combined with one or more pieces of contextualizing data, is referred to as retrieval-augmented generation (RAG).

In many instances, the quality of the content generated by a generative AI model is related to the quality of the prompt. Generally, the more detailed and instructive the prompt is, the more accurate and responsive to the prompt the generated content will be. There are, however, limitations to this, and different generative AI models will have different levels of responsiveness and/or limits on the amount of context that can be provided within a prompt. Therefore, it is beneficial to have a process wherein only the best contextualizing data and instructions are provided so avoid delays in responsiveness for the generative AI model and to avoid issues with providing context that requires too much memory for the generative AI model to properly operate with.

As such, in some embodiments, a prompt compiler (or “prompt compiler module”) may be used to combine the single-statement response capturing the content of a message from a user along with dynamically selected contextualizing data chunks into a compiled prompt that may be sent to a generative AI model. In some embodiments, the prompt compiler may select a prompt template from a prompt template library (discussed below) before combining the prompt template with other data. In some such embodiments, the prompt compiler may use one or more rule trees, decision trees, or other algorithms to select a prompt template. In some other embodiments, the prompt compiler may be configured to select prompt templates only from a defined subset of the total available prompt templates stored in the prompt library. As a non-limiting example, there may be certain users that have instructions specific to the use of a particular generative AI model, and the prompt compiler may be configured with instructions to limit the prompt templates it may use for those user to only prompt templates that are intended for that particular generative AI model.

ii. Prompt Template Library

As discussed above, in some embodiments of the present disclosure, one or more prompt templates may be stored within the platform in a prompt template library. In some embodiments, the prompt templates may be strings of text that include instructions and or role-assignment information for a generative AI model. In some embodiments, the prompt templates may be indexed and stored within the prompt template library alongside one or more metadata tags that may be used to help organize and locate pertinent prompt templates. In some embodiments, the prompt template library may receive updates to prompt templates or may be configured to periodically request updates to prompt templates in response to updates to relevant generative AI models.

iii. API Interface Module

The platform of the present disclosure may be used in connection with one or more generative AI models. There are many types of generative AI models available for use and they produce varied types of outputs. Some produce text, while others produce visual/graphical content, video content, audio content, etc. As will be appreciated by one skilled in the art, even within the same class of generative AIs, like LLMs, there may be differences in the training provided to those LLMs or the number of parameters that the LLMs work with that will affect the output of those LLMs. The platform of the present disclosure may, in some embodiments, thus include an API interface module to allow the generative AI module to send prompts to, and receive responsive generated content from, one or more generative AI models. The generative AI models may, in some embodiments, be external to the platform, i.e., be hosted by a third party on its own hardware/servers. In some other embodiments, the generative AI model, or models, may include “internal” generative AI models, i.e., models that are hosted within the platform. Both internal and external generative AI models are discussed in more detail below.

a. Internal Generative AI Models

There are a number of different generative AI models that are available to be hosted within the platform of the present disclosure. These include smaller LLM models, smaller indicating that they utilize fewer parameters, and a variety of visual generative AI models. The use of such models may, in some embodiments, provide additional control over the platform, as updates and changes to the internal generative AI models may be overseen the platform. The use of internal generative AI models may also, in some embodiments, provide increased data security by preventing potentially sensitive or proprietary training data from having to be transmitted outside of the platform itself.

In some embodiments, the API interface module may use one or more internal API protocols to send compiled prompts to the one or more internal generative AI models. In some embodiments, the internal generative AI models may be microservices running within the operating environment of the generative AI module, the agent, or the platform.

b. External Generative AI Models

External generative AI models are hosted on external, third-party servers. These external generative AI models may, in some embodiments, include one or more API libraries that define how information may be sent to and received from them. In some embodiments, the API interface module may store the API protocols for one or more external generative AI models and use the APIs for those external generative AI models to send prompts to them.

### VII. Post-Conversation Analysis Module

When a user has completed a chat session with the platform, in some embodiments, a post-conversation analysis module may be configured to send the transcript of the chat session along with one or more contextualizing data chunks and/or instructions to a generative AI model, internal or external, to have a summary of the chat transcript produced. In some embodiments, a breakdown of the key discussion points may be requested. In some other embodiments, a vector embedding of the chat transcript may be requested to allow for the chat transcript to be vectorized and stored in a vector database.

In some embodiments, the post-conversation analysis module may also request from a generative AI models one or more dynamic data points regarding the user that participated in the chat session. In some other embodiments, the post-conversation analysis module may also request the generative AI model to generate a personalized conversation starter that may be used to initiate or guide a subsequent chat session with the user. These features are discussed in greater detail within the user profile sections below.

### VIII. Memory Management Module

Some embodiments of the platform of the present disclosure may include a memory management module configured to organize, store, and search one or more vectorized databases of data chunks and to vectorize received data chunks to facilitate the dynamic RAG process. In some embodiments, the operations of the memory management module may be carried out by one or more sub-modules. These are discussed in detail below.

i. Vectorized Database Module

Some aspects of embodiments of the present disclosure are directed to the use of indexed vector databases that may be configured to store data chunks that may be used as contextualizing information within the RAG process. The data chunks may, in some embodiments, be one or more digital files containing text, audio, video, graphical, or numeric data. In some embodiments, the data chinks are processed by a vector embedding algorithm to produce a vectorization, i.e., multi-dimensional vector representation, of the content stored within the data chunk. The vector representations of the data chunks may then be indexed and stored within a searchable form within the vectorized database module within one or more databases. In some embodiments, techniques such as tree-based partitioning or hashing may be used to facilitate faster retrieval of the indexed vectorized data chunks.

a. Vector-Search Module

As discussed above regarding the router, in some embodiments the memory management module may include a vector-search module to perform searches of the indexed vectorized data stored by the vectorized database module. As will be understood by one skilled in the art, there are many different algorithms for performing searches of the indexed data, and all suitable search algorithms as would be known to one skilled in the art are within the scope of the present disclosure. As a non-limiting example, this may include the cosine similarity analysis described in regard to the search comparator of the router. In some embodiments, the operations described above for the search comparator may be carried out by the vector-search module.

ii. Vectorization Module

Some embodiments of the memory management module may include a vectorization module. The vectorization module may be configured to process one or more received data chunks using a vector embedding algorithm to produce a multi-dimensional vector representation of the content of the one or more received data chunks. In some embodiments, the vectorization module may include instructions and/or API protocol libraries to allow for the vectorization module to send data chunks and instructions to a generative AI model, internal or external, to process the vector embedding of the content of the data chunks.

iii. Vectorized Chat Transcript Database

When a chat session with a user is terminated, in some embodiments, the chat transcript of the terminated session may be vectorized and stored within an indexed database. This may, in some embodiments, allow for the content of the chat transcript to be easily searched and located for use in future chat sessions with the user.

iv. Knowledge Base Database Module

Some aspects of embodiments of the present disclosure are directed to providing generative AI enhanced leadership coaching. In some embodiments, the platform of the present disclosure uses one or more RAG processes to carry out the preparation of responsive generated leadership coaching communications that may be sent to a user. The contextualizing data for the RAG process may, in some embodiments, be pulled from a knowledge base database module. The knowledge database module may, in some embodiments, include one or more databases containing indexed and vectorized data chunks. In some embodiments, the knowledge base database module may keep separate database for leadership coaching materials and client-specific resource that may be used as contextualizing data. These are discussed in more detail below.

a. Client Resource Database

Individual users or users within an organization may have specific policies, goals, and/or requirements for the leadership coaching that they need to receive from the platform of the present disclosure. Accordingly, in some embodiments, a client resource database may be included to organize and store data pertaining to the specific needs of a user or client. For example, within the context of leadership coaching on dispute resolution, an organization may have specific policies regarding reporting of disputes between employees. Those policies may be stored within the client resource database and utilized within the RAG process as contextualizing data to help ensure that the platform provides leadership coaching that considers the specific organizational policies.

b. Leadership Coaching Database

Leadership coaching materials, including training modules, lesson plans, lectures, presentations, courses, handouts, and guides may all be used as contextualizing information within the platform of the present disclosure. The leadership coaching materials, as discussed above, may, in some embodiments, be vectorized and indexed within a leadership coaching database. This may, in some embodiments, allow for the memory management module and the router to dynamically locate the most pertinent leadership coaching materials available to help generate personalized and responsive answers and guidance for one or more users.

v. Chat History Database

In some embodiments, the platform of the present disclosure may include a chat history database to store transcripts of completed chat sessions with one or more users. In some embodiments, the chat transcripts may be stored directly within a database. In some other embodiments, the chat transcripts may be vectorized and indexed within a vector database.

In some embodiments, the chat history database may use SQL. However, there are many suitable types of databases and database structures that may be suitable for this purposes, and all such databases and structures as would be known to be suitable for this purpose by one skilled in the art are within the scope of the present disclosure.

### IX. User Database

Leadership coaching is often improved by providing individualized feedback and mentoring to participants. While there may be generalized coaching objectives and lessons, different individuals may respond better or worse to certain types of coaching or require additional coaching on specific topics. To facilitate this type of individualized coaching, some embodiments of the platform of the present disclosure may include a user database, or “user database module” to organize and store user profile records for individual users. Additionally, the use of user profiles may, in some embodiments, allow the platform to track the individual use of the platform by a user and therefore facilitate the individualized coaching of multiple users in parallel within an organization.

i. User Profiles

In some embodiments, individual users may have unique user profiles or user profile records stored within the platform. The user profiles may contain information about the user, an organization that the user belongs to, and a variety of other information describing the user and his or her use of the platform. As will be understood by one skilled in the art, the user profiles may be structured in a variety of ways and be stored in different types of database structures. As a non-limiting example, the user profiles may be stored within a relational database structure. All suitable database structures as would be known to one skilled in the art may be used within the scope of the present disclosure.

Examples of some of the data that may be stored within or associated with a user profile are described in detail below.

a. Dynamic Data Point

In some embodiments a “dynamic data point” may be associated with a user and stored in or associated with his or her user profile. The dynamic data point may include one or more pieces of information that pertain to the interactions of the user with the platform. This may include, but is not limited to, behavioral analysis based on the chat history of the user, progress through one or more leadership coaching modules, coaching and or performance-related metrics for the user, and/or data regarding the user's demographic/employment information.

In some embodiments, the post-conversation analysis module may request that a generative AI module generate an updated dynamic data point for a user in response to the completion of a chat session with the platform. This may, in some embodiments, make the platform more individualized for each user, as their most recent interactions with the platform may be used to create contextualizing data for their subsequent interactions with the platform.

b. Personalized Conversation Starter

In some embodiments, one or more users may be sent personalized conversation starters to prompt them to begin a chat session with the platform or to continue one or more leadership coaching modules or lessons. In some other embodiments, the platform may use a personalized conversation starter to direct a conversation with a user during a chat session initiated by the user.

In some embodiments, the post-conversation analysis module may request that a generative AI module generate an updated personalized conversation starter for a user in response to the completion of a chat session with the platform. This may, in some embodiments, make the platform more individualized for each user, as their most recent interactions with the platform may be used to create a conversation start to help initiate or guide their next chat session with the platform.

c. User Permission Set

Some embodiments of the present disclosure are directed to providing a dynamic generative AI enhanced leadership coaching platform that may provide individualized coaching to one or more users across an organization in parallel. In some embodiments, this may be facilitated, in part, by the use of user permission sets associated with the user profiles for each user. The user permission sets may contain user-level or individual level permissions that relate to the database access granted to an individual user. The user permission sets may also contain organization-level permissions that define access levels for groups of users within an organization.

### X. Figures and Flowcharts

Further understanding of the structure of some embodiments of the present disclosure may be had by reference to the following figures and flowcharts.

FIG. 1 is a simplified depiction of the relationship of the modules of a dynamic generative-AI enhanced leadership coaching platform, according to aspects of some embodiments of the present disclosure.

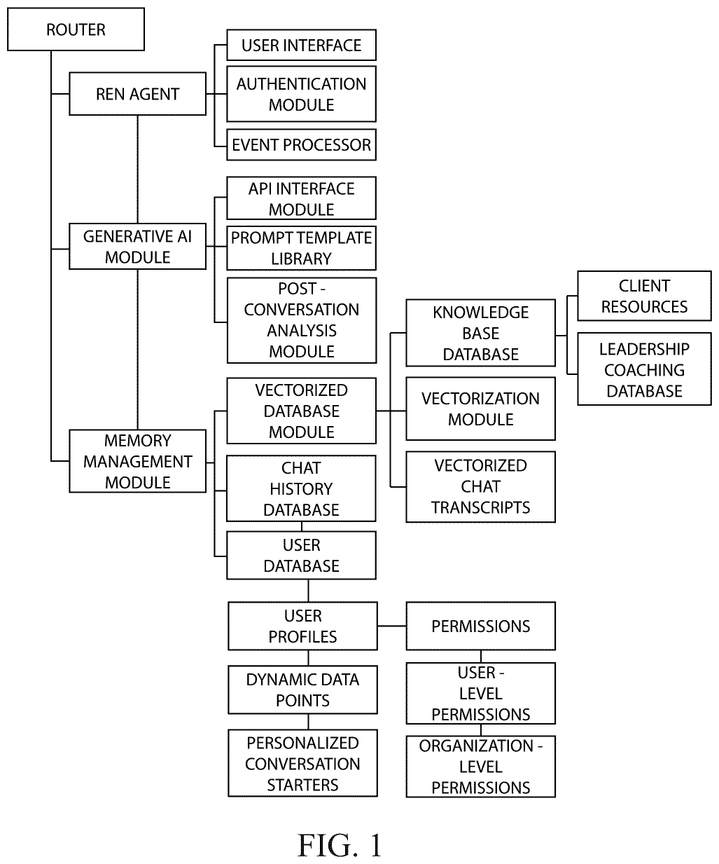

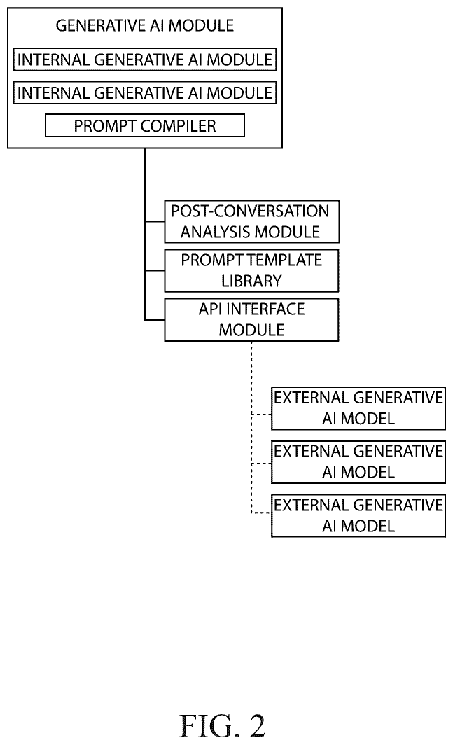

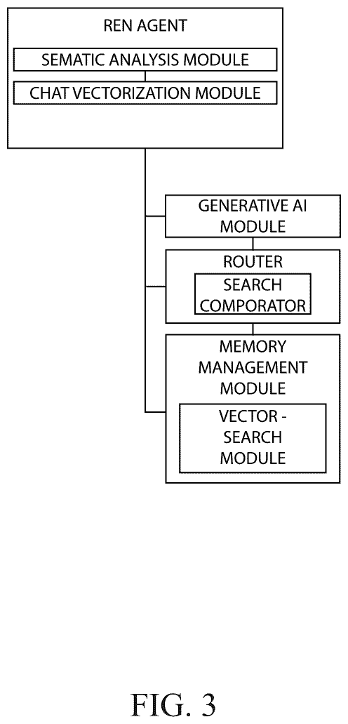

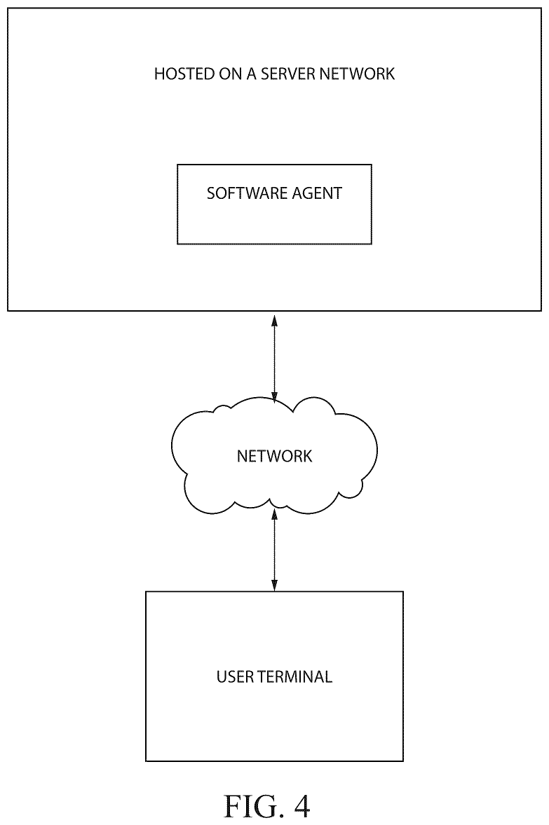

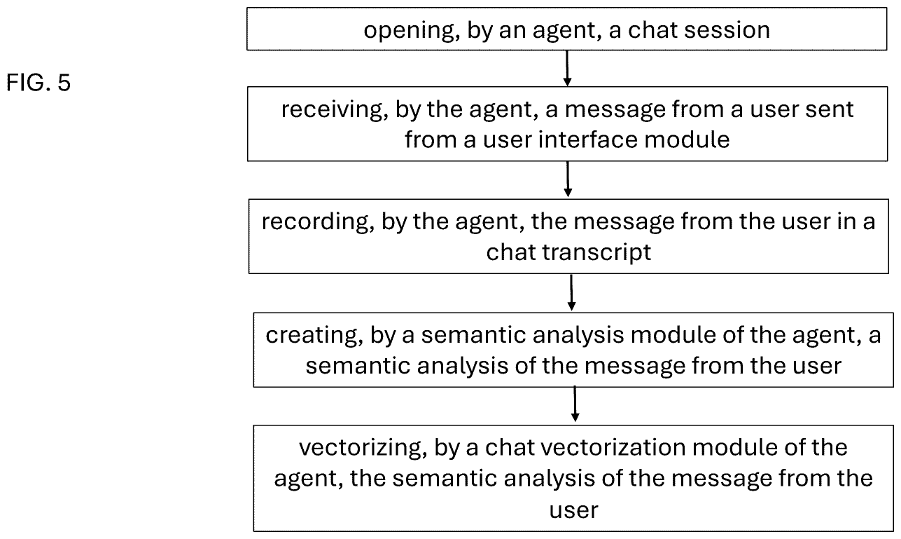

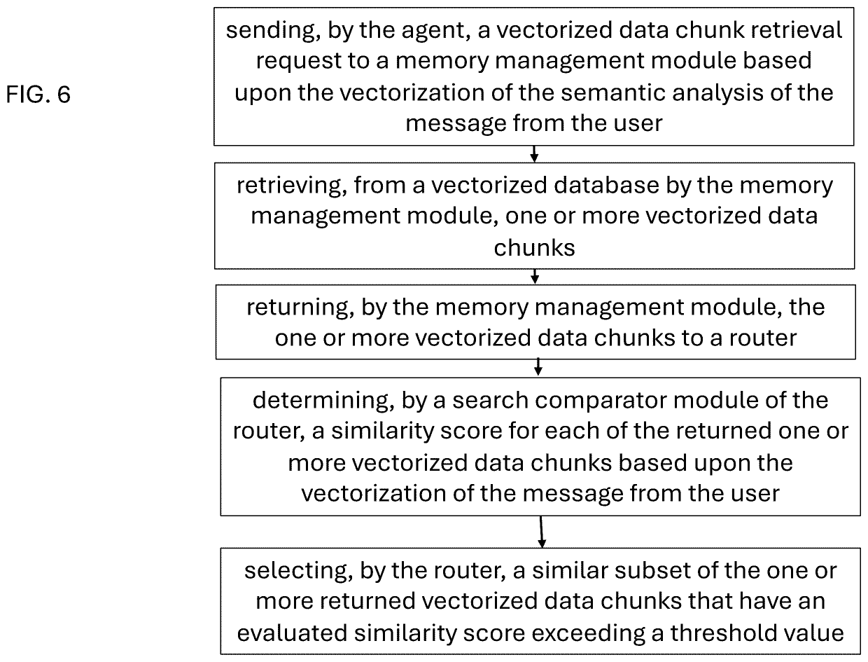

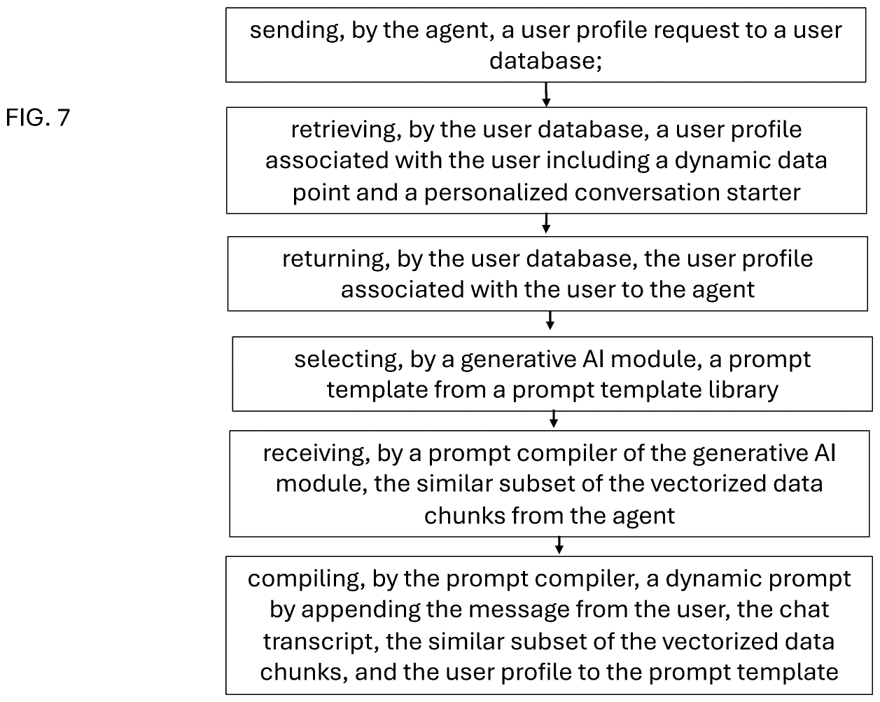

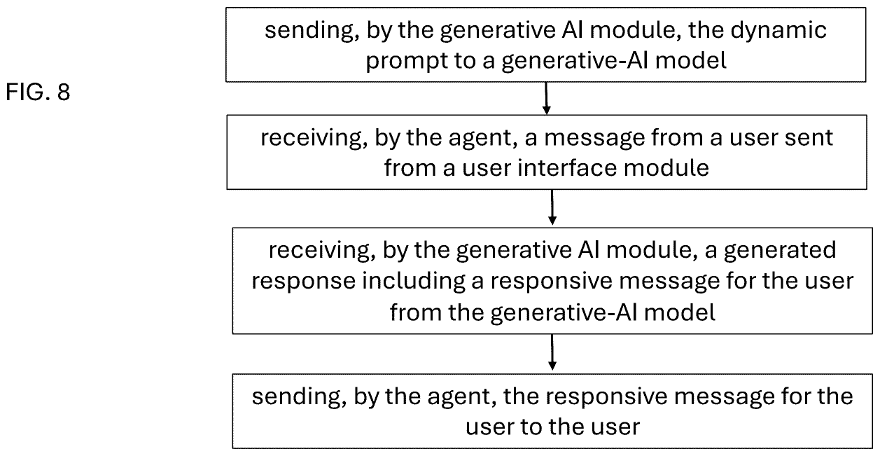

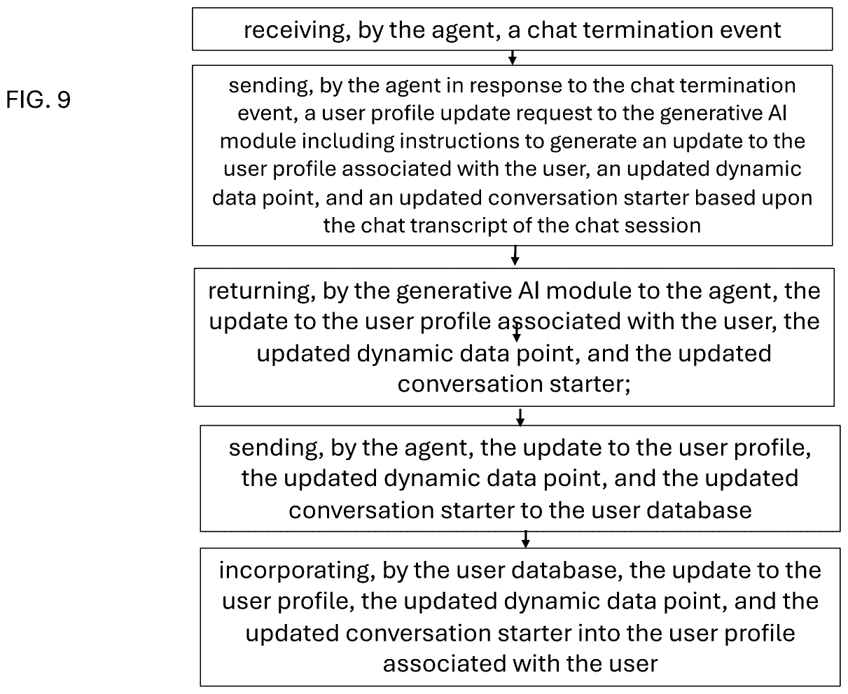

As shown, in some embodiments, the agent may be in communication with the authentication module, the event processor module, and the user interface module. The agent may also, in some embodiments, be in communication with the router, the memory management module, and the generative AI module of the present disclosure.

As depicted, in some embodiments, the generative AI module may be in communication with an API interface module, a prompt template library module, and a post-conversation analysis module.

As shown, in some embodiments, the memory management module may be in communication with a vectorized database module, a chat history database, and a user database. In some embodiments, the vectorized database module may be in communication with a knowledge base database, vectorization module, and a vectorized chat transcript database. The knowledge base database may, in some embodiments, be in communication with a client resource database and a leadership coaching database.

The user database may, in some embodiments, contain user profiles. The user profiles may, in some embodiments, contain or be associated with, dynamic data points, personalized conversation starters, and user permission sets. In some embodiments, the user permission sets may contain or be associated with user-level permissions and organization-level permissions.

FIG. 2. Is a simplified depiction of a generative AI module, according to aspects of embodiments of the present disclosure.

As depicted in some embodiments, the generative AI module may include one or more internal generative AI models. In some embodiments, the generative AI module may also include a prompt compiler.

The generative AI module may also, in some embodiments, be in communication with a post-conversation analysis module, a prompt template library, and an API interface module.

As depicted, in some embodiments, the generative AI module may be in communication via a network with one or more external generative AI models.

FIG. 3 is a simplified depiction of an agent in communication with a generative AI module, a router, and a memory management module, according to some aspects of embodiments of the present disclosure.

As shown, in some embodiments, the agent may include a semantic analysis module and a chat vectorization module.

The router may, in some embodiments, be in communication with the agent and include a search comparator.

As shown, the memory management module may be in communication with the agent and the router and it may include a vector search module.

FIG. 4 is a simplified diagram depicting a user terminal in communication over a network with an agent hosted on a server network, according to some aspect of embodiments of the present disclosure.

FIG. 5 is a flowchart describing the process of a chat session being opened and a message from a user being vectorized, according to some aspects of embodiments of the present disclosure.

As will be understood by one skilled in the art, the chat session may be opened, or otherwise initiated, in response to an input from or user or in response to a schedule event carried out by the platform.

In some embodiments, the steps described for this process may be carried out in parallel for multiple users at overlapping times.

FIG. 6 is a flowchart describing the process of a dynamic search for one or more vectorized data chunks, according to some aspects of embodiments of the present disclosure.

In some embodiments, the steps described for this process may be carried out in parallel for multiple users at overlapping times.

FIG. 7 is a flowchart describing the process of requesting user profile data and combining it with one or more vectorized data chinks to compile a dynamic prompt, according to some aspects of embodiments of the present disclosure.

In some embodiments, the steps described for this process may be carried out in parallel for multiple users at overlapping times.

FIG. 8 is a flowchart describing the process of receiving generated content from a generative AI model and sending a responsive message to a user, according to some aspects of embodiments of the present disclosure.

As will be understood by one skilled in the art, the received generated content may be in any form or format as requested by the platform in response to the message received from the one or more users, and the responsive message may be in any form or format. This may include text, audio, video, numeric data, and any other type of data that may be stored in one or more digital files.

FIG. 9 is a flowchart describing the process of updating a user profile in response to a chat termination event, according to some aspects of embodiments of the present disclosure.

As used herein, “chat termination event” and “chat session termination event” may be used interchangeably.

As will be appreciated by one skilled in the art, the chat termination event may be any signal or communication that indicates the end of a chat session, or, alternatively, the chat termination event may be the receipt of such a message or signal by the agent. In some embodiments, the sending of the chat termination event message or signal may be initiated by one or more users. In some other embodiments, the agent or the user interface module may be configured to automatically trigger a chat termination event based on a preprogrammed rule or in response to a lack of input received from the one or more users.

In some embodiments, the steps described for this process may be carried out in parallel for multiple users at overlapping times.

It will be understood that embodiments described herein should be considered in a descriptive sense only and not for purposes of limitation. Descriptions of features or aspects within each exemplary embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claim. It should be noted that although examples of the invention are set forth herein, the claims, and the full scope of any equivalents, are what define the metes and bounds of the invention.

What is claimed is:

1. A dynamic generative-AI enhanced leadership coaching platform, comprising:
an agent comprising:
a semantic analysis module; and
a chat vectorization module;
an authentication module configured to authenticate one or more users in response to receiving one or more user authentication credentials;
an event processor configured to schedule tasks performed by the agent;
a user interface module configured to send and receive messages from one or more authenticated users during a chat session;
a router having a search comparator module;
a generative AI module comprising:
a prompt compiler module;
a post-conversation analysis module configured to send prompt-based instructions to the generative AI module to generate an analysis and summary of a chat transcript of messages from the one or more authenticated users during the chat session and to receive the analysis and summary from the generative AI module;
a prompt template library configured to be accessible to the prompt compiler of the generative AI module;
an API interface module configured to communicate with one or more generative AI models using an API interface available for each generative AI model, respectively;
a memory management module having a vector-search module;
a vectorized database module configured to store vectorized data records and be accessible to the memory management module;
a vectorization module configured to vectorize data;
a knowledge base database module configured to catalogue vectorized data;
a client resource database accessible to the knowledge base database module and configured to store client resource materials;
a leadership coaching database accessible to the knowledge base database module and configured to house leadership coaching materials;
a chat history database configured to store the chat transcript;
a user database configured to store a user profile; and
a user profile stored in the user database.

2. The dynamic generative-AI enhanced leadership coaching platform of claim 1, wherein the messages from the one or more authenticated users during the chat session comprise audio recordings.

3. The dynamic generative-AI enhanced leadership coaching platform of claim 1, wherein the search comparator module of the router is configured to select one or more vectorized data records returned by the vector-search module in response to an evaluation of the cosine similarity of the one or more vectorized data records against a threshold value.

4. The dynamic generative-AI enhanced leadership coaching platform of claim 1, wherein the one or more generative AI models comprise an internal generative AI model.

5. The dynamic generative-AI enhanced leadership coaching platform of claim 1, wherein the one or more generative AI models comprise an external generative AI model.

6. The dynamic generative-AI enhanced leadership coaching platform of claim 1, wherein the user profile comprises;
a dynamic data point;
a personalized conversation starter; and
a user permission set;
wherein the user permission set comprises a user-level permission and an organization-level permission.

7. The dynamic generative-AI enhanced leadership coaching platform of claim 6, wherein the one or more authenticated users are each assigned an access level to one or more vectorized data records according to the user-level permission of each of the one or more authenticated user's user profile, respectively.

8. The dynamic generative-AI enhanced leadership coaching platform of claim 6, wherein the one or more authenticated users are each assigned an access level to one or more vectorized data records according to the organization-level permission of each of the one or more authenticated user's user profile, respectively.

9. The dynamic generative-AI enhanced leadership coaching platform of claim 1, wherein the dynamic data point includes one or more components of the analysis and summary of the chat transcript according to the instructions of the post-conversation analysis module.

10. The dynamic generative-AI enhanced leadership coaching platform of claim 1, wherein the post-conversation analysis module is configured to instruct the generative AI module to generate the summary and analysis of the chat transcript in response to a chat session termination event.

11. A method for providing a dynamic generative-AI enhanced leadership coaching platform, comprising:
opening, by an agent, a chat session;
receiving, by the agent, a message from a user sent from a user interface module;
recording, by the agent, the message from the user in a chat transcript;
creating, by a semantic analysis module of the agent, a semantic analysis of the message from the user;
vectorizing, by a chat vectorization module of the agent, the semantic analysis of the message from the user;
sending, by the agent, a vectorized data chunk retrieval request to a memory management module based upon the vectorization of the semantic analysis of the message from the user;
retrieving, from a vectorized database by the memory management module, one or more vectorized data chunks;
returning, by the memory management module, the one or more vectorized data chunks to a router;
determining, by a search comparator module of the router, a similarity score for each of the returned one or more vectorized data chunks based upon the vectorization of the message from the user;
selecting, by the router, a similar subset of the one or more returned vectorized data chunks that have an evaluated similarity score exceeding a threshold value;
sending, by the agent, a user profile request to a user database;
retrieving, by the user database, a user profile associated with the user including a dynamic data point and a personalized conversation starter;
returning, by the user database, the user profile associated with the user to the agent;
selecting, by a generative AI module, a prompt template from a prompt template library;
receiving, by a prompt compiler of the generative AI module, the similar subset of the vectorized data chunks from the agent;
compiling, by the prompt compiler, a dynamic prompt by appending the message from the user, the chat transcript, the similar subset of the vectorized data chunks, and the user profile to the prompt template;
sending, by the generative AI module, the dynamic prompt to a generative-AI model;
receiving, by the generative AI module, a generated response including a responsive message for the user from the generative-AI model; and
sending, by the agent, the responsive message for the user to the user.

12. The method for providing a dynamic generative-AI enhanced leadership coaching platform of claim 11, further comprising:
receiving, by the agent, a chat termination event;
sending, by the agent in response to the chat termination event, a user profile update request to the generative AI module including instructions to generate an update to the user profile associated with the user, an updated dynamic data point, and an updated conversation starter based upon the chat transcript of the chat session;
returning, by the generative AI module to the agent, the update to the user profile associated with the user, the updated dynamic data point, and the updated conversation starter;
sending, by the agent, the update to the user profile, the updated dynamic data point, and the updated conversation starter to the user database;
incorporating, by the user database, the update to the user profile, the updated dynamic data point, and the updated conversation starter into the user profile associated with the user.

13. The method for providing a dynamic generative-AI enhanced leadership coaching platform of claim 11, wherein the vectorized data chunks comprise a data file and a vector embedding.

14. The method for providing a dynamic generative-AI enhanced leadership coaching platform of claim 13, wherein the similarity score is determined by performing a cosine similarity evaluation between the vector embeddings of the vectorized data chunks and the vectorization of the semantic analysis of the message from the user.

15. The method for providing a dynamic generative-AI enhanced leadership coaching platform of claim 11, wherein the generative AI model comprises a large language model.

16. The method for providing a dynamic generative-AI enhanced leadership coaching platform of claim 11, further comprising:
requesting, by the agent, a permission set associated with the user profile of the authenticated user; and
sending, by the agent, the permission set associated with the user profile to the memory management module to define a portion of the vectorized database that may be searched.

17. An organization-wide dynamic generative-AI enhanced leadership coaching platform, comprising:
an authentication module configured to authenticate a plurality of users;
a user interface module configured to send and receive messages;
an agent configured to instantiate a plurality of independent chat sessions associated with one or more of the plurality of users, respectively;
a user database comprising a plurality of user profiles for each respective user of the plurality of user;
a memory management module; and
a generative AI module;
wherein the agent is configured to run two or more of the plurality of independent chat sessions at the same time;
wherein the agent sends search requests based on vectorized semantic analyses of chat transcripts of the two or more independent chat sessions to the memory management module; and
wherein the memory management module returns to the agent one or more vectorized data chunks for each search request that are selected based on similarity and then compiled into one or more dynamic prompts sent by the agent to the generative AI module.

18. The organization-wide dynamic generative-AI enhanced leadership coaching platform of claim 17, wherein the agent is further configured to, in response to a chat session termination event for one of the plurality of independent chat sessions, send a chat transcript from the terminated chat session alongside an instructive prompt to the generative AI module to request an update to the user profile of the user associated with the terminated chat session and an updated dynamic data point associated with the user profile of the user associated with the terminated chat session.

19. The organization-wide dynamic generative-AI enhanced leadership coaching platform of claim 17, wherein the user profile for each respective user of the plurality of users includes one or more permission levels defining a portion of a knowledge base database that may be accessed by the user.

20. The organization-wide dynamic generative-AI enhanced leadership coaching platform of claim 17, wherein the agent is configured to produce an audit report describing trends in the chat sessions for one or more of the plurality of users.
